(19) United States
(12) Patent Application Publication
(10) Pub. No.: US 2007/0020073 A1
(43) Pub. Date: Jan. 25, 2007

(54) System, method and apparatus for loading tractor trailers

(76) Inventor: Scott Chaddock, Clearwater, FL (US)

Correspondence Address: LARSON AND LARSON, 11199 69TH STREET NORTH, LARGO, FL, 33773, US

(21) Appl. No.: 11/176,170

(22) Filed: Jul. 7, 2005

(51) Int. Cl. B60P 1/04

(52) U.S. Cl. 414/483

(57) ABSTRACT

A wheel suspension system for a trailer. The wheels are attached to a wheel truck assembly that is slideably attached to a rail system mounted to the bottom of the trailer. The wheel truck assembly is slideable along the rail system to a section of rail that is moveable, the moveable section is slideably interfaced to a vertical rail system so that the wheel truck assembly and the moveable section retracts into a wheel truck compartment as the trailer is lowered to the pavement, allowing loading and unloading while keeping the contents substantially level.

### BACKGROUND OF THE INVENTION

1. Field of the Invention

This invention relates to the field of trailers and more particularly to a system for loading and unloading a trailer while keeping the trailer level.

2. Description of the Prior Art

Trailers are used throughout the world for transporting goods. Some trailer systems consist of a powered truck cab, usually diesel powered, and a detachable trailer. The powered truck cab usually has 6 to 10 wheels, two in the front capable of steering the vehicle and 4 to 8 in sets of two in the back where the trailer attaches for supporting the load of the trailer. The trailer usually has 8 wheels in sets of two, closely spaced to each other and near the back of the trailer for supporting the load. The trailer may be an open flat-bed or a closed box with doors or may be a specialty trailer such as those used to transport automobiles. Some trailer systems are in different configurations and are designed to be pulled by a car, sport utility vehicle, pickup truck, or the like. These trailers often have one set or two sets of wheels.

In general, the vehicle is detachable from the trailer so that the trailers may be loaded or unloaded while the vehicle is used to transport other trailers or for other purposes instead of sitting idle, waiting for the trailer to get loaded. Trailers are loaded in many different ways. One is to back the trailer up to a loading dock which is roughly the same height as the trailer bed, whereby goods are moved onto or off of the trailer, perhaps using forklifts or the like. In some applications, goods are raised up to the trailer bed, either by moving the goods up a ramp or using a lifting device to lift them. In some applications, the rear of the trailer is lowered to allow goods to be placed or taken out from the ground level.

Unfortunately, there are some goods that need to remain virtually level during the loading and transporting process. For example, some companies are starting to use storage containers to transport household goods, whereby a storage container (large box) is dropped at a home, the homeowner loads the box, the box is picked up and put on a trailer, moved to a new home and dropped off for the homeowner to unload. Being that the homeowner is probably not experienced in packing these containers, they may not have everything tightly packed. If the containers are loaded by pulling or moving them up a ramp or tilted trailer, the contents may experience a 7 to 45 degree tilt, shifting the contents and possibly damaging them. Furthermore, many injuries occur in moving goods up to the level of the trailer deck, both in personal strain or when the goods become unstable and fall.

One solution to this problem is to use a lifting device or hoist, requiring heavy machinery at both the loading and unloading site.

What is needed is a trailer that can be easily transitioned so as to provide a trailer deck that is substantially parallel with the ground and that is substantially at ground level.

### SUMMARY OF THE INVENTION

In one embodiment, a system for lowering a trailer is disclosed including a trailer for transporting goods with a front end, a back end, a deck surface and at least one rail mounted to an underside of the load surface. A wheel truck compartment is located at the front end of the trailer and has a wheel truck compartment load surface on the top and a wheel truck compartment barrier surface on the side where it interfaces with the deck surface. Included is a wheel truck assembly comprising at least one set of wheels adapted to a wheel truck frame. The wheel truck frame slideably interfaces with the at least one rail to enable the wheel truck assembly to slide along the at least one rail. At least one moveable rail is positioned as a continuation of the at least one rail and is slideably interfaced with at least one vertical rail mounted to the wheel truck compartment. The at least one moveable rail is able to move vertically up and down within the wheel truck compartment.

In another embodiment, a method of lowering a trailer is disclosed including lifting the trailer to take pressure off a wheel truck assembly, the trailer having a front end and a back end. At least one rail affixed to a bottom side of the trailer. Next, sliding the wheel truck assembly to the front of the trailer, passing the full length of the at least one rail and passing onto at least one moveable rail that is slideably attached to at least one vertical rail. Then lowering the trailer so that the wheel truck assembly retracts into a wheel truck compartment, lowering until the trailer rests on a pavement.

In another embodiment, an apparatus for lowering a trailer is disclosed including a wheel truck assembly, the wheel truck assembly including a set of wheels and a slideable connection, the set of wheels for interfacing with a roadway and the slideable connection for interfacing with a set of rails, the set of rails affixed to an underside of the trailer and a set of moveable rails extending from a front end of the set of rails, the set of moveable rails slideably interfaced to a set of vertical rails. The wheel truck assembly is moveable to the set of moveable rails and when moved to the set of moveable rails, the wheel truck assembly retracts into a wheel truck compartment when the trailer is lowered.

### BRIEF DESCRIPTION OF THE DRAWINGS

The invention can be best understood by those having ordinary skill in the art by reference to the following detailed description when considered in conjunction with the accompanying drawings in which:

FIG. 1 illustrates a side view of a system of a first embodiment of the present invention with the wheel truck assembly in its riding position.

FIG. 2 illustrates a side view of a system of a first embodiment of the present invention with the wheel truck assembly in its forward position.

FIG. 3 illustrates a side view of a system of a first embodiment of the present invention with the wheel truck assembly in its retracted position.

FIG. 4 illustrates a close-up view of a system of a first embodiment of the present invention with the wheel truck assembly in its forward position.

FIG. 5 illustrates a close-up view of a system of a first embodiment of the present invention with the wheel truck assembly in its retracted position.

FIG. 6 illustrates a schematic view of the operation of an embodiment of the prior art.

FIG. 7 illustrates a schematic view of the operation of another embodiment of the present invention.

FIG. 8 illustrates a schematic view of the operation of the first embodiment of the present invention.

### DETAILED DESCRIPTION OF THE INVENTION

Reference will now be made in detail to the presently preferred embodiments of the invention, examples of which are illustrated in the accompanying drawings. Throughout the following detailed description, the same reference numerals refer to the same elements in all figures. In the described embodiments, the term “rollers” is used to describe the interface between moveable components. Although rollers are a good interface, providing ease of movement, many other slideable interfaces are possible such as two flat surfaces with or without a lubricant. Any known slideable interface is included in the description of the present invention. Furthermore, the term jack is used throughout as a way to raise and lower the trailer and should be construed in its broadest meaning as a device to lift and lower a heavy object. A jack is any mechanical device for doing such, including ratchet-type and hydraulic types.

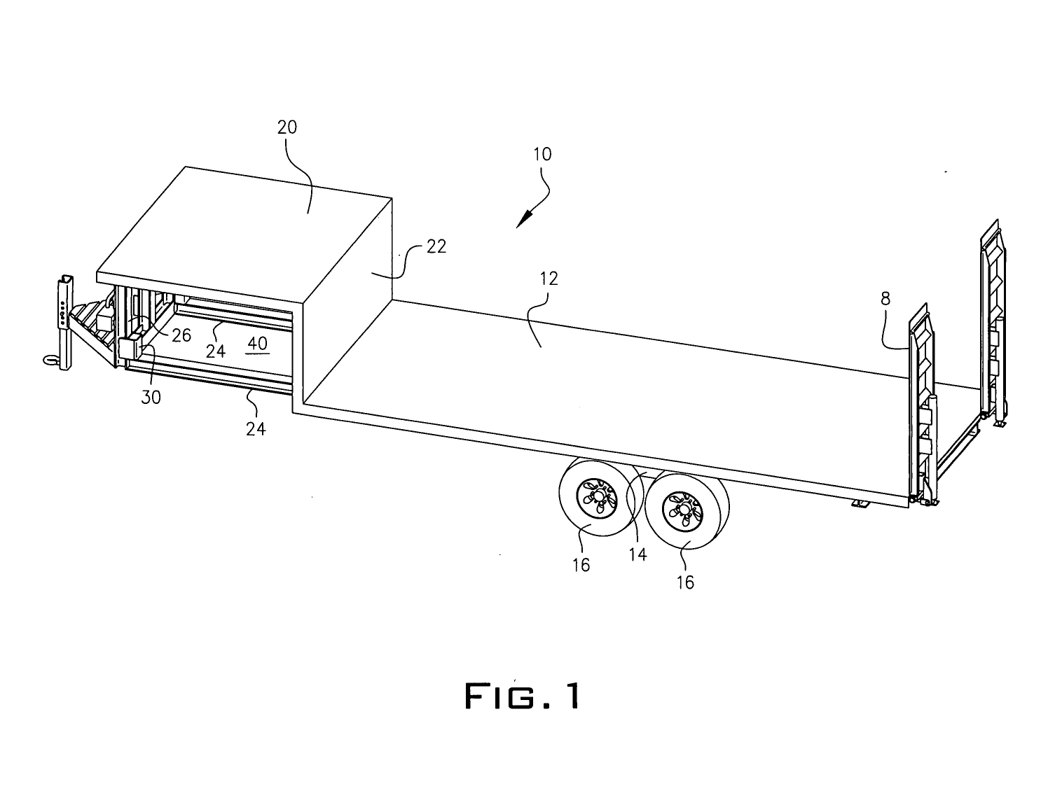

Referring to FIG. 1, a side view of a system of a first embodiment of the present invention with the wheel truck assembly in its riding position is shown. A trailer 10 has a load surface or trailer deck 12 for carrying goods and a wheel truck assembly 14 with sets of wheels 16. A wheel truck compartment 40 has a wheel truck compartment deck surface 20 that is optionally loaded with goods and a wheel truck compartment barrier surface 22. The wheel truck compartment has at least one moveable rail 24 and at least one vertical rail 26. In some embodiments, one or more ramps 8 are provided to aid in loading and unloading the trailer 10. Although shown as a flat-deck trailer in this example, the present invention applies equally well to all types of trailers including enclosed trailers. In some embodiments, there are one or more locking pins to hold the wheel truck in place while the trailer is in motion and may engage in multiple positions to locate the wheels in a position that will balance the load.

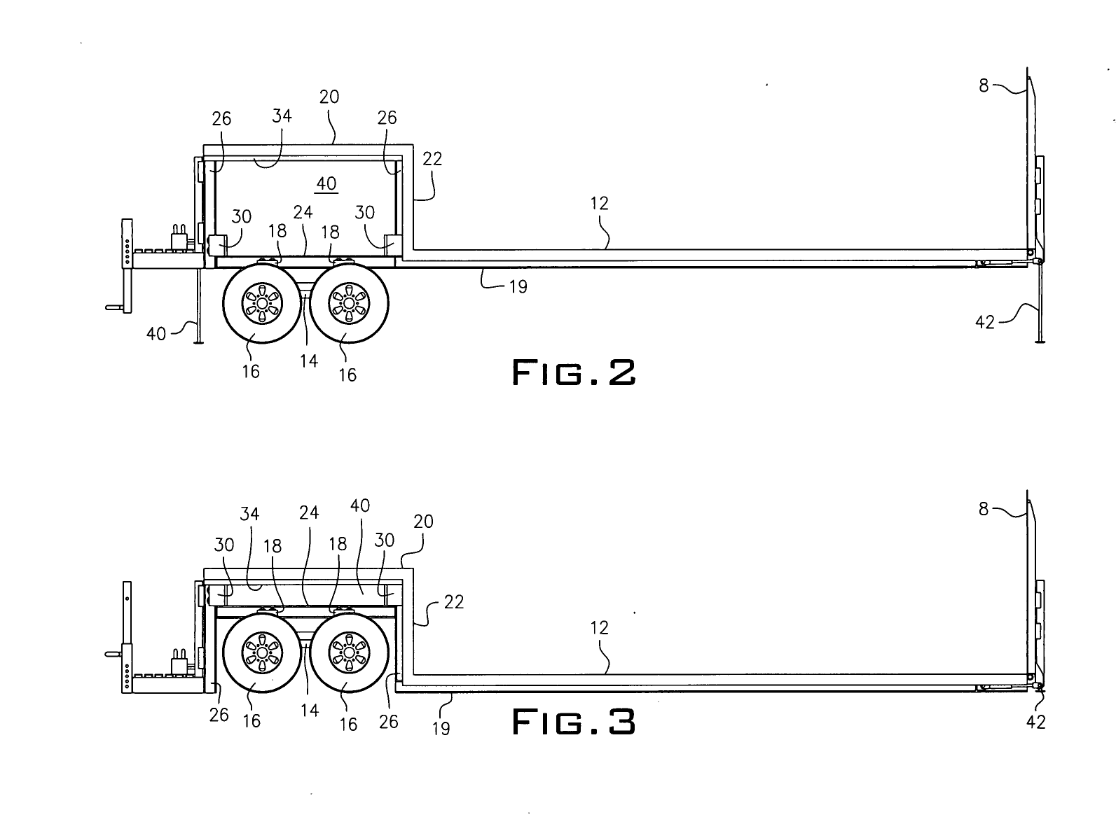

Referring to FIG. 2, a side view of a system of a first embodiment of the present invention with the wheel truck assembly in its forward position is shown. In this view, the trailer 10 has been raised by a front jack 40 and two rear jacks 42 so that at least most of the weight of the trailer 10 and its contents are supported by the jacks 40/42 so that the wheel truck assembly 14 and wheels 16 can slide along the at least one rail 19 mounted to the underside of the load surface 12. It is preferred to have at least two rear jacks 42 to maintain stability. In some embodiments there are two rear jacks 42 integrated into the ramps 8 so that when the trailer is lowered (as in FIG. 3), the jacks 42 are contained in the ramps 8 and when the ramps 8 are lowered, the jacks are lowered with them and do not impede loading and unloading. A set of rollers 18 interface with the rails 19 to permit movement of the wheel truck assembly. In one embodiment, the rails 19 are in the form of I-beams and the set of rollers 18 rest within the I-pattern. The set of rollers 18 are preferably attached by bearings to a plurality of axles, the plurality of axles being attached to the wheel truck assembly. Although shown as an I-beam and rollers, any form of slideable interface is possible without veering from the present invention, including two smooth surfaces, either with or without a lubricant. The at least one rail 19 may also provide structural support to the load surface 12.

The wheel truck assembly 14 is shown in its fully forward position, in that the plurality of rollers 18 have traveled the length of the rails 19 and are positioned on the moveable rails 24 that are the same or similar shape as the rails 19, forming a continuous rail on which the set of rollers 18 can travel. Visible in this view is a support beam 34 and vertical rails 26 that let the wheel truck assembly 14 and the moveable rails 24 move into the wheel truck compartment by use of a second set of rollers 30 (or slideable interface) connected to the moveable rails 24 and slideably interfacing with the vertical rails 26. Although four vertical rails 26 are shown, any number is possible.

Referring to FIG. 3, a side view of a system of a first embodiment of the present invention with the wheel truck assembly in its retracted position is shown. The wheel truck assembly 14 is shown in its fully forward position, in that the plurality of rollers 18 have traveled the length of the rails 19 and are positioned on the moveable rails 24 that are the same or similar shape as the rails 19, forming a continuous rail on which the set of rollers 18 can travel. Visible in this view is a support beam 34 and vertical rails 26 that let the wheel truck assembly 14 and the moveable rails 24 move into the wheel truck compartment by use of a second set of rollers 30 connected to the moveable rails 24 and interfacing with the vertical rails 26. In this view, the jacks 40/42 have been retracted, lowering the trailer 10 so that it rests on the ground or pavement, the wheel truck assembly 14 and wheels 16 retracting into the wheel truck compartment 40. The wheel truck assembly 14 is in position on the moveable rails 24 so that as the trailer 10 is lowered, the wheel truck assembly 14 and the moveable rails 24 retract into the wheel truck compartment 40 along the vertical rails 26 with help from the second set of rollers 30.

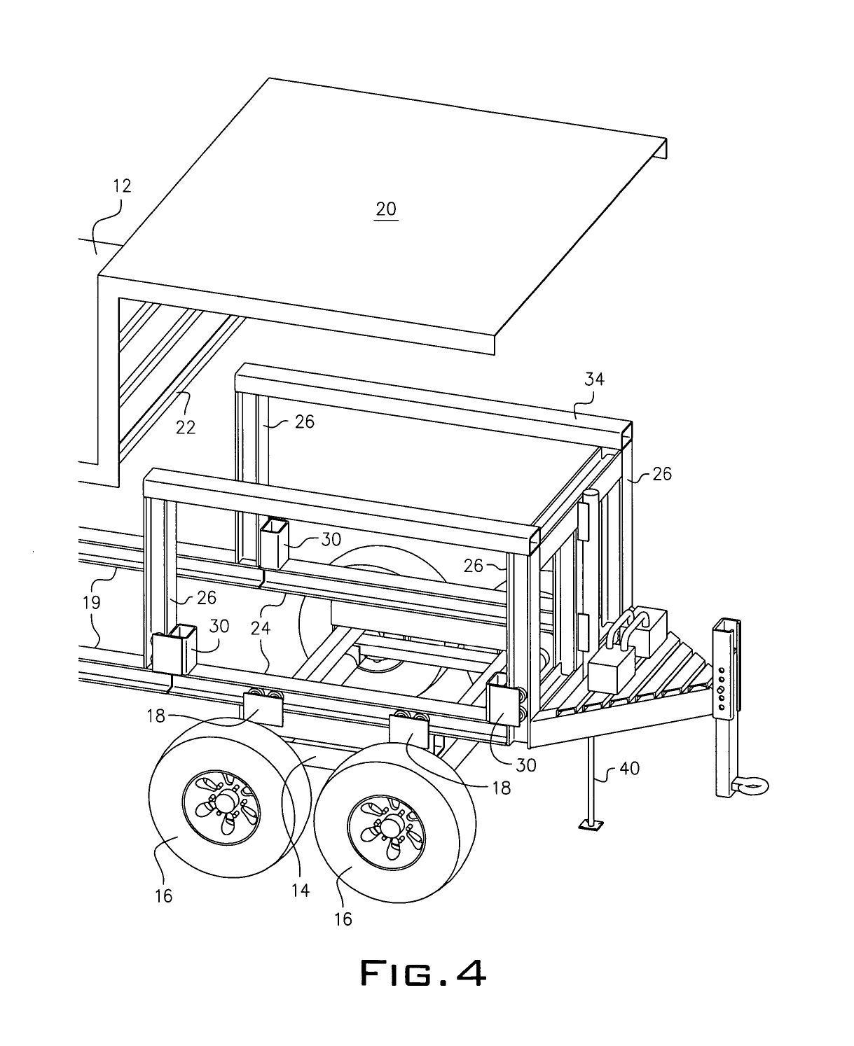

Referring to FIG. 4, a close-up view of a system of a first embodiment of the present invention with the wheel truck assembly in its forward position is shown. The front end of the rails 19 are visible, interfacing with the moveable rails 24. The wheel truck assembly 14 has two pairs of wheels 16 attached, although any number of wheel pairs is possible. The wheel truck assembly 14 is shown interfacing with the moveable rails 24 by two sets of rollers 18, though any number of rollers is possible. The moveable rails 24 are connected to a second set of rollers 30, which interface with the vertical rails 26. In this view, the wheel truck compartment deck surface 20, wheel truck compartment barrier 22 and load surface 12 are shown lifted so internal components are visible. An optional support beam 34 is shown connecting the at least one vertical rail 26. In this view, the trailer 10 is lifted off the ground by the jacks 40/42.

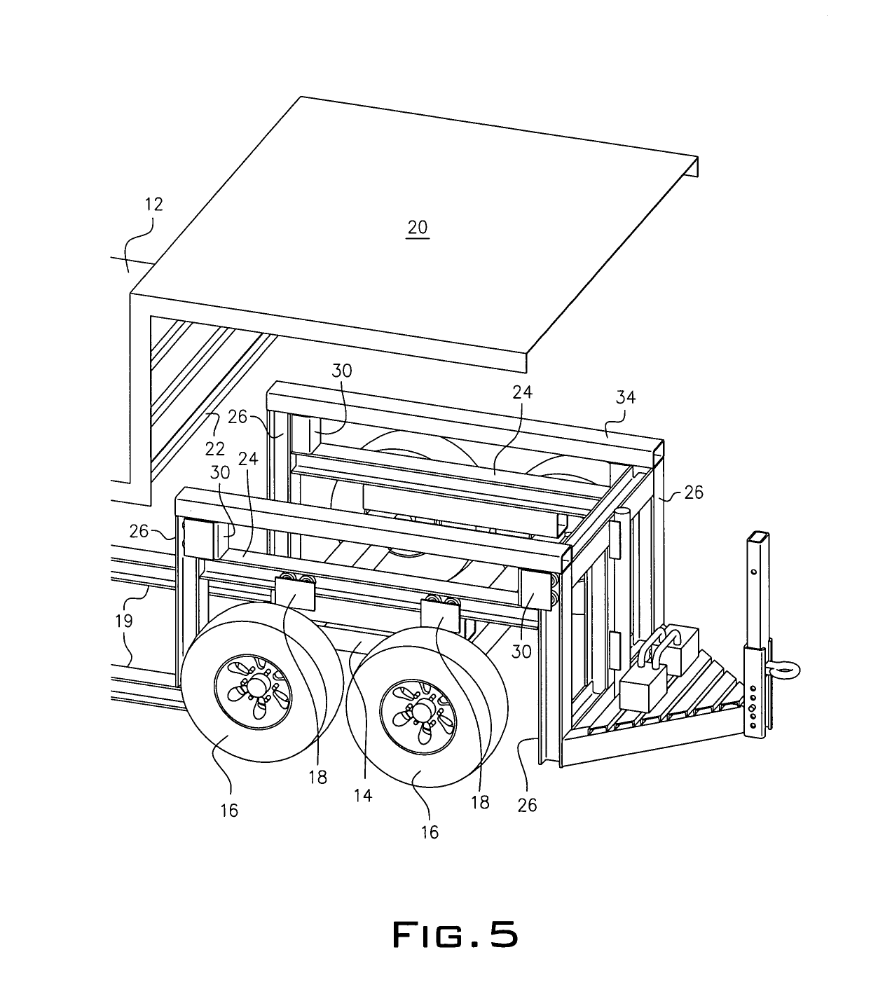

Referring to FIG. 5, a close-up view of a system of a first embodiment of the present invention with the wheel truck assembly in its retracted position is shown. The front end of the rails 19 are visible, interfacing with the moveable rails 24. The wheel truck assembly 14 has two pairs of wheels 16 attached, although any number of wheel pairs is possible. The wheel truck assembly 14 is shown interfacing with the moveable rails 24 by two sets of rollers 18, though any number of rollers is possible. The moveable rails 24 are connected to a second set of rollers 30, which interface with the vertical rails 26. In this view, the wheel truck compartment deck surface 20, wheel truck compartment barrier 22 and load surface 12 are shown lifted so internal components are visible. An optional support beam 34 is shown connecting the at least one vertical rail 26. In this view, the jacks 40/42 have been retracted and the trailer 10 is resting on the ground and the wheel truck assembly 14 has retracted into the wheel truck compartment 40.

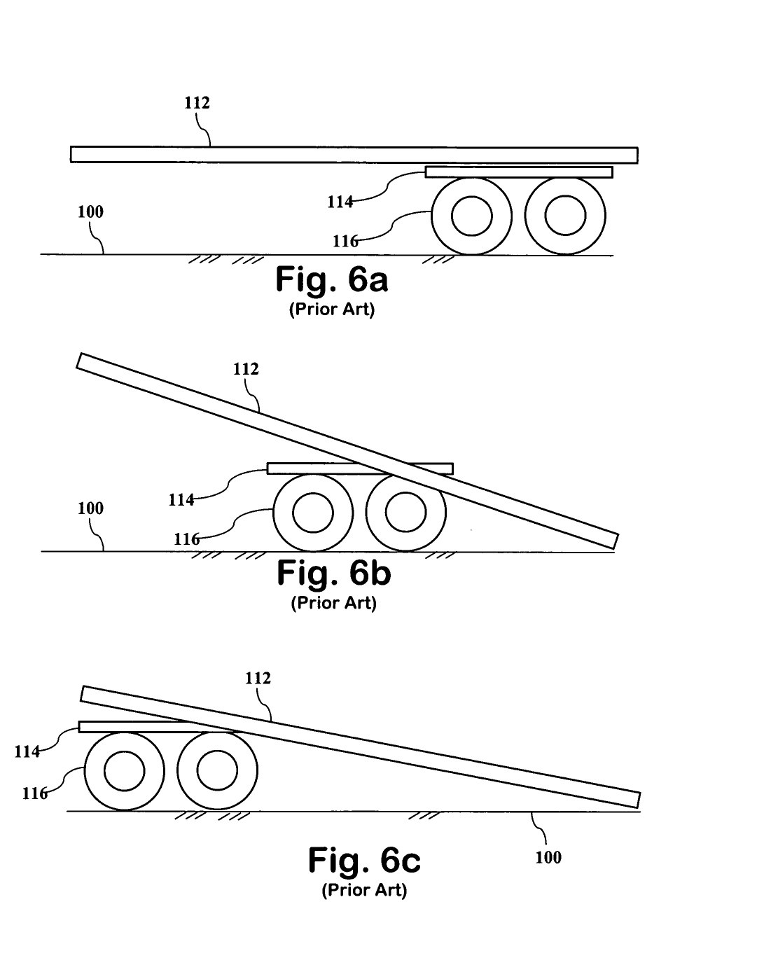

Referring to FIG. 6a-FIG. 6c, a schematic view of the operation of an embodiment of the prior art is shown. A trailer deck 112 has a moveable wheel truck assembly 114 with wheels 116 attached. The rails, rollers and jacks are not shown for simplicity. In this scenario, the wheel truck assembly 114 is moved along the trailer deck 112 along the pavement 100 until the wheel truck assembly 114 is in the forward position as in FIG. 6c. Note that the trailer deck 112 is at a transition angle in FIG. 6b and still at a considerable angle in FIG. 6.c. Any goods in or on the trailer during the transition angle may shift during the transition and considerable effort is required to overcome the loading angle as shown in FIG. 6c. In this prior art, heavy duty hydraulic cylinders are required to push or pull the wheel truck assembly 114 along the trailer deck 112.

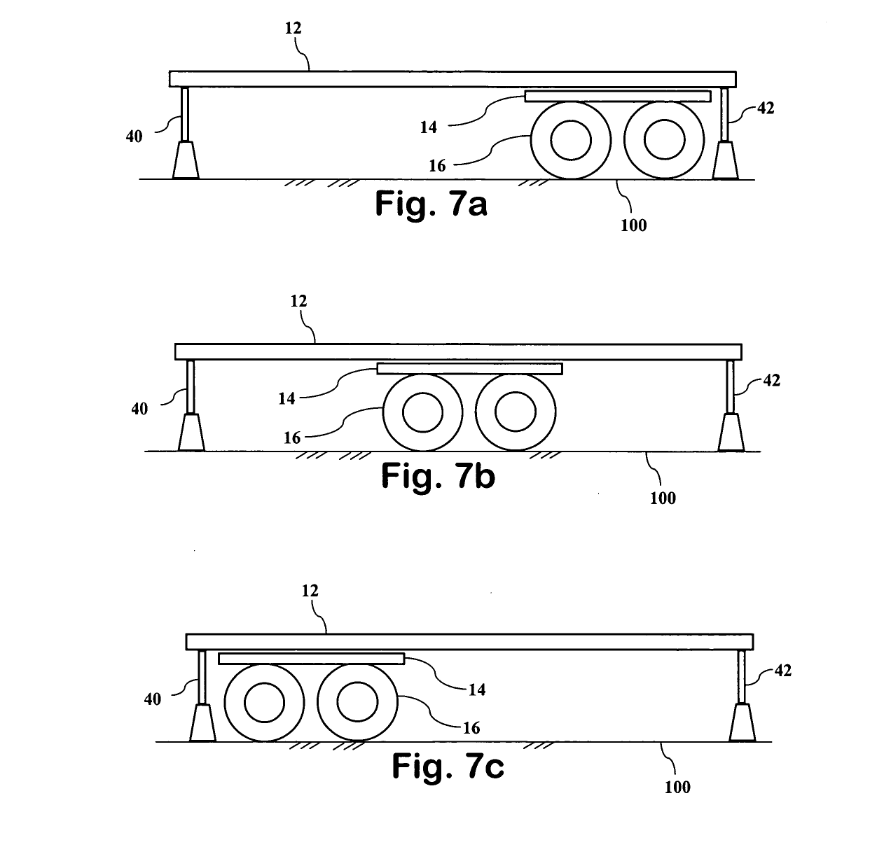

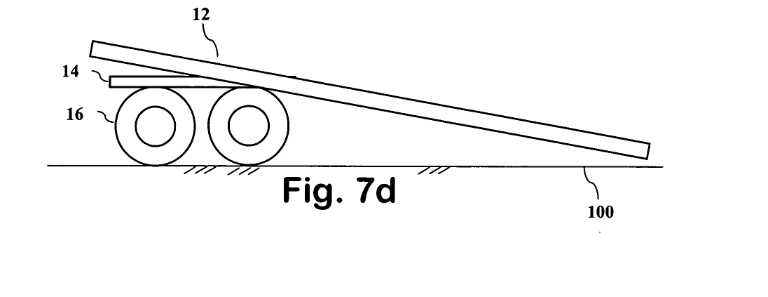

Referring to FIG. 7a-FIG. 7d, a schematic view of the operation of another embodiment of the present invention is shown. A trailer deck 12 has a moveable wheel truck assembly 14 with wheels 16 attached. The rails and rollers are not shown for simplicity. In this scenario, the trailer is raised on jacks 40/42 and the wheel truck assembly 14 is moved along the trailer deck 12 along the pavement 100 until the wheel truck assembly 14 is in the forward position as in FIG. 7c. Note that the trailer deck 12 remains level with the pavement 100 even through the transition phase as in FIG. 7b and the forward position as in FIG. 7.c. Once the wheel truck assembly 14 is in the forward position, the rear jacks 42 are lowered and moved out of the way and the rear of the trailer deck 12 rests on the pavement 100 and the front of the trailer deck 12 rests on the wheel truck assembly 12, forming a loading angle as shown in FIG. 7d. This method provides a slight angle to assist in unloading, for example, a disabled vehicle, as shown in FIG. 7d. In some embodiments, the rear jacks 42 are integrated into the ramps 8 and, once retracted, fold down with the ramps 8.

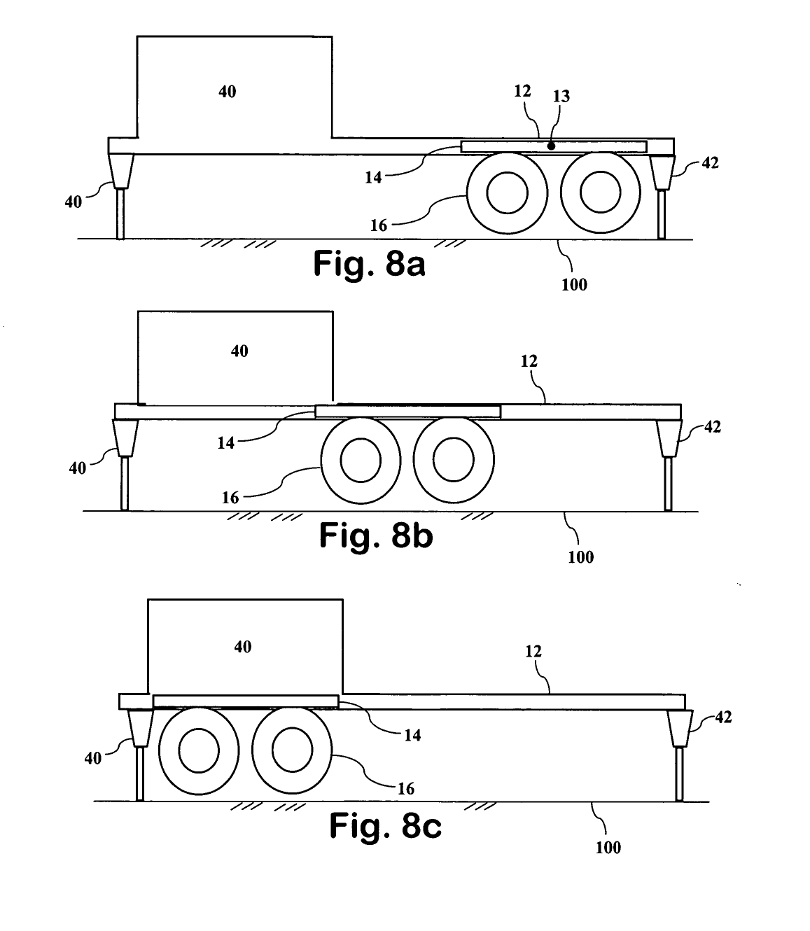

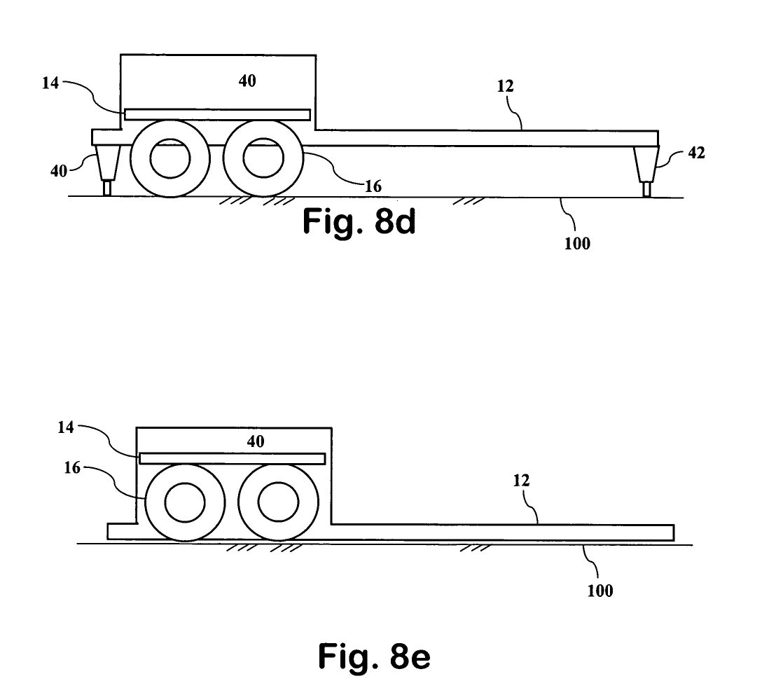

Referring to FIG. 8, a schematic view of the operation of the first embodiment of the present invention is shown. A trailer deck 12 has a moveable wheel truck assembly 14 with wheels 16 attached. The rails and rollers are not shown for simplicity. In this scenario, a locking pin 13 is released and the wheel truck assembly 14 is moved along the trailer deck 12 along the pavement 100 until the wheel truck assembly 14 is in the forward position as in FIG. 8c. Any goods in or on the trailer during the movement of the wheel truck assembly 14 remain level with the pavement 100 during this transition as shown in FIG. 8a-FIG. 8e. Once the wheel truck assembly 14 is in the forward position, as shown in FIG. 8c, the jacks 40/42 are lowered in tandem. The trailer 10 is shown partially lowered in FIG. 8d and completely lowered in FIG. 8e. As the trailer 10 is lowered, the wheel truck assembly 14 retracts into the wheel truck compartment 40, shown partially retracted in FIG. 8d and fully retracted n FIG. 8e. Once lowered, goods are loaded or unloaded from the trailer without the need of any significant ramps and without subjecting the goods to any significant tilting. In some embodiments, a very small ramp is used to provide a smooth transition, allowing wheeled trucks and fork lifts to easily get to the height of the trailer deck 12.

Equivalent elements can be substituted for the ones set forth above such that they perform in substantially the same manner in substantially the same way for achieving substantially the same result.

It is believed that the system and method of the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely exemplary and explanatory embodiment thereof. It is the intention of the following claims to encompass and include such changes.

What is claimed is:

1. An apparatus for lowering a trailer, the apparatus comprising:
a trailer for transporting goods, the trailer having a front end, a back end and a deck surface; the trailer having at least one rail mounted to an underside of the deck surface;
a wheel truck compartment at the front end of the trailer, a wheel truck compartment deck surface on a top of the wheel truck compartment and a wheel truck compartment barrier surface on a side of the wheel truck compartment interfacing with the deck surface;
a wheel truck assembly, the wheel truck assembly comprising at least one set of wheels adapted to a wheel truck frame, the wheel truck assembly slideably interfaced with the at least one rail to enable the wheel truck assembly to slide along the at least one rail; and
at least one moveable rail positioned in parallel and positioned as a continuation of each of the at least one rail, the at least one moveable rail slideably interfacing with at least one vertical rail, the at least one vertical rail mounted to the wheel truck compartment such that the at least one moveable rail is able to move vertically up and down within the wheel truck compartment.

2. The apparatus for lowering a trailer of claim 1, wherein the trailer is a flat-bed trailer.

3. The apparatus for lowering a trailer claim 1, wherein the trailer is a box trailer.

4. The apparatus for lowering a trailer of claim 1, wherein the at least one rail consists of two rails and the at least one moveable rail consists of two moveable rails and the at least one vertical rail consists of four vertical rails.

5. The apparatus for lowering a trailer of claim 4, wherein the two rails are I-beams and the two moveable rails are I-beams and the four vertical rails are I-beams.

6. The apparatus for lowering a trailer of claim 1, further comprising at least one locking pin, the at least one locking pin holding the wheel truck assembly in place during transportation.

7. The apparatus for lowering a trailer of claim 1, wherein the at least one set of wheels is eight wheels connected to the wheel truck frame by axles and bearings.

8. The apparatus for lowering a trailer of claim 7, wherein the at least one rail provides structural support.

9. A method for lowering a trailer comprising:
lifting the trailer to take pressure off of a wheel truck assembly, the trailer having a front end, a back end, and a deck surface, the wheel truck assembly slideably interfaced with at least one rail, the at least one rail affixed to a bottom side of the deck surface;
sliding the wheel truck assembly to the front of the trailer, passing the full length of the at least one rail, the wheel truck assembly passing from the at least one rail onto at least one moveable rail, the at least one moveable rail slideably interfaced with at least one vertical rail; and
lowering the trailer so that the wheel truck assembly retracts into a wheel truck compartment, lowering until the trailer rests on a pavement.

10. The method for lowering a trailer of claim 9, wherein the at least one rail is two parallel rails and the at least one moveable rail is two moveable rails and the at least one vertical rail is four vertical rails.

11. The method for lowering a trailer claim 9, wherein the wheel truck assembly is slideably interfaced with the at least one rail by a plurality of rollers.

12. The method for lowering a trailer of claim 9, wherein the lifting and lowering are performed using a plurality of jacks, at least one of said plurality of jacks substantially located near the front end of the trailer and another at least one of said plurality of jacks substantially located near the back end of the trailer.

13. The method for lowering a trailer of claim 12, further comprising two folding ramps, wherein the another at least one of said plurality of jacks located near the back end of the trailer are two jacks and each of the two jacks is integrated into each of the two folding ramps.

14. The method for lowering a trailer of claim 9, further comprising removing at least one locking pin before said sliding.

15. The method for lowering a trailer of claim 9, wherein the trailer is a flat-deck trailer.

16. The method for lowering a trailer of claim 9, wherein the trailer is an enclosed trailer.

17. An apparatus for lowering a trailer, the apparatus comprising:
a wheel truck assembly, the wheel truck assembly including a wheel means and a slideable connection means, the wheel means for interfacing with a roadway and the slideable connection means for interfacing with a rail means, the rail means affixed to an underside of the trailer; and
a moveable rail means extending from a front end of the rail means, the moveable rail means slideably interfaced to a vertical rail means;
whereas the wheel truck assembly is moveable to the moveable rail means and whereas when moved to the moveable rail means, the wheel truck assembly retracts into a wheel truck compartment when the trailer is lowered.

18. The apparatus for lowering a trailer of claim 17, wherein the slideable connection means includes a plurality of rollers.

19. The apparatus for lowering a trailer of claim 18, wherein the moveable rail means is slideably interfaced to the vertical rail means by a second plurality of rollers.

20. The apparatus for lowering a trailer of claim 17, wherein the trailer is a flat-deck trailer.

21. The apparatus for lowering a trailer of claim 17, wherein the trailer is an enclosed trailer.
